(19) United States
(12) Patent Application Publication
(10) Pub. No.: US 2007/0005665 A1
(43) Pub. Date: Jan. 4, 2007

(54) Separation of duties in a data audit system

(75) Inventors: Lev Vaitzblit, Concord, MA (US); Jonathan T. Jesse, Hollis, NH (US); Gregory George, Cambridge, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Lumigent Technologies, Inc., Acton, MA (US)

(21) Appl. No.: 11/174,294

(22) Filed: Jun. 30, 2005

(51) Int. Cl. G06F 17/30

(52) U.S. Cl. 707/202

(57) ABSTRACT

A database audit system monitors database activity, providing a complete record of access to data and database structure. A database audit may be performed by collecting data from database transaction logs and traces, exporting the collected data into a repository, and analyzing the data in the repository to create data audit reports and to provide data audit browsing capabilities. A separation between audit side and audited data side is maintained through limited access permissions.

### BACKGROUND OF THE INVENTION

Enterprises today rely on database technology to run their businesses. Mission-critical and other data assets stored in the databases need to be safeguarded from inappropriate access and data changes. The need to protect data security and privacy has become of paramount concern to most organizations. Reasons for this concern include customer or supplier requirements, business practices, security policies and government regulations. Beyond what is commonly understood by “security,” that is, preventing unauthorized access, there is a driving need for data access accountability: knowing who is doing what to which data and by what means, and doing so in a way that is safe from tampering.

Capturing a record of data accesses is a key step in maintaining the data accountability, yet common existing approaches may miss certain kinds of activity, introduce a false sense of security or interfere with runtime database performance. These approaches include application modification, mid-tier portals and trigger-based collection at the data source.

Application modification entails changing source code of every application that might be used to access the data of interest. Each application is changed so that it captures data modification and viewing information and stores it for further processing. Because each application must be modified, application modification can substantially increase the implementation cost of compliance with data auditing requirements. This may be especially true where legacy systems must be brought into compliance. In addition, this approach requires each application to be modified and does not capture activity outside the modified application, thus reducing confidence in the completeness of the audit trail. The audit trail may be incomplete because operations not handled by the modified applications may be missed, or because the audit does not record access directly to the underlying database, or because the audit trail itself has been tampered with.

The mid-tier portal approach funnels access to data from multiple applications or users through a shared portal that is responsible for the backend access. This portal can be modified to capture and store data access information. As with the application modification approach, the mid-tier portal approach may pose potential risks because operations and accesses outside of the portal enabled applications may be missed by the audit trail. Implementation costs may be high as well because other approaches to creating audit trails would be needed where data were not created, modified, or deleted through the portal-enabled applications. This limitation of the portal approach may make it an especially inappropriate solution for many legacy systems that contain data subject to the data auditing requirement.

The most common way of capturing data modification is using database triggers. A trigger is a special-purpose application logic that is executed when predetermined events occur. Triggers have a number of drawbacks: they are often hard to write correctly, they add substantial runtime performance overhead because they execute in line with transactions, they cannot capture data views, and they cannot generally capture changes to database schema and permissions. In addition, triggers may easily be disabled without detection. The performance cost often leads database administrators to minimize the number of triggers implemented, thus reducing completeness of the audit trail.

How a data access accountability solution captures the appropriate data for an audit trail is as important as determining what data should be captured. Once the appropriate level of detail for the audit trail is determined, an effective solution should provide confidence that all the relevant activities that create, modify or delete data will be captured and activities will not inadvertently or fraudulently be omitted from the audit trail.

### SUMMARY OF THE INVENTION

A data audit system designed to help organizations address data privacy and security requirements with a complete audit of database activity may provide answers to the questions “who is doing what to which data when?” Such a system may be designed to provide a complete record of access to data and database structure. The audit trail may be protected by enforcing a “separation of duties” between auditors and data maintainers. The separation of duties means restricting access to the audit trail from those who have permissions to modify data being audited and vice versa. That is, those with access to the data should not have access to the audit trail and those with access to the audit trail should not have access to the audited data.

The task of safeguarding data assets is multi-faceted, but a central aspect is ensuring that data is changed only in intended ways and that only the proper parties have access to the data or the audit trail. Implementing suitable privacy and security policies and mechanisms is an important step, but it does not address two important realities: even authorized users will sometimes access data inappropriately, whether deliberately or accidentally, and flaws in policy and implementation can introduce vulnerability, enabling unintended data access or database changes. Therefore, independent data audit trails are needed to capture information about data modification and accesses.

The “independence” of the audit trail and data being audited may be one way—that is, where the audit process is independent of the authentication process necessary to modify the target data—or two way, where the authentication process for the audit trail is also independent of the target database authentication process.

There are two aspects to enforcing the independence of the audit: (1) restricting control over the audit system, so it cannot be compromised by those whose activities are monitored on the target database, and (2) ensuring that the audit trail is not accessible to those whose activities are captured in the trail.

Databases generally maintain a transaction log, a log of all data modifications, that is used as a master record for recovery and backup purposes. The data from the transaction log may also be gathered and used for the data audit purposes.

Typically, database servers provide an interface for executing functions during run time in response to particular events, and for maintaining a record of processed queries. Such functions may be triggers, during execution of which other database activities are suspended, or may be callback functions, execution of which does not hold up processing of the database queries. Trace data and data collected by the callback functions may also be used to create a data audit trail. A combination of the transaction log and trace data may provide information about the internal database activity.

The database being monitored is usually accessed through an authentication process, ensuring that only authorized agents, users or maintainers may modify or access the database. The authentication process may employ passwords, tokens, bio-authentication, or any other system as deemed appropriate by one of skill in the art.

A database audit may be performed by collecting data about the internal database activity by one or more agents, exporting the collected data into a repository, and analyzing the data in the repository. The collection agents monitor the internal database activity according to a set of configuration parameters. The configuration parameters may indicate which database(s) or data to monitor, when and where to collect it, where to store it and in which format, etc. The operation of a collection agent may be independent of access to the target monitored database through the authentication process. That is, an agent may have limited permissions on the target machine and might not have the ability to modify the target database in any way.

The collection agents may ensure continuity and non-overlap of the collected data. Such continuity may be maintained, for example, by using database checkpoint markers to delineate separate collection processes. The collection processes may be run at the predetermined intervals, or may be started by a user from a management console.

A configuration manager may be used to control and configure the configuration parameters of collection agents and other audit system settings. The configuration manager may be accessed through an authentication system, the access being limited to those who have appropriate permissions. The configuration manager authentication process technology may be similar to or different from the target database authentication process. The audit system may be set up in such a way that users having access to the configuration manager do not have write access to the target database being monitored. That is, those who can modify the audit trail and what data the collection agents monitor might not be able to modify data in the target database. In turn, database managers having access to the target database might not have authentication to access the configuration manager and/or repositories in which data is stored. Separation of duties is maintained through this restricted access and audit data is protected from tampering, because no single individual or agent has permissions to modify both the target database and the audit trail or control of the audit or its parameters.

All the modifications to the target database are audited and may be tracked, and correspondingly, it is possible to track the audit data in the repositories and to ensure its integrity. The separation of duty arrangement protects the data audit from a situation where someone may be able to modify the target database and then modify the audit in such a way as to prevent others from finding out about the modification to the target database. While it is rarely possible to protect a system from tampering under all possible scenarios, separating the access to the target data and audit data provides a technical solution to one type of data audit problem.

The audit collection agents may have limited access to the target databases, such as, for example, only read access. Because they only need limited permissions on the target database server, their installation may be completed by audit specialists rather than target database maintainers. Similarly, the installation of the configuration manager and its performance may be monitored by audit specialists and should not be performed by target database maintainers. The audit process does not involve setting up database triggers, because they may be disabled without detection by database administrators, which violates the separation of duty.

The database audit system may be employed on several databases, where the databases audited may be of different types, for example, SQL Server and Oracle databases. The audit information from the different databases may be stored in the same repository and may be analyzed later without regard to which database it came from, or it may be stored on multiple independent repositories.

The repositories may be located on machines physically and/or logically separate from those containing target databases. In order to further protect the integrity of the audit, collected data may be encrypted while in transit between the collection agents and audit repositories. In an alternative embodiment of the invention, audit data may be stored in the repository database in an encrypted format.

The database audit system may be implemented across multiple platforms, operating across a local network or across the Internet. Various details of the database audit system may be modified by one skilled in the art according to the purpose of the particular embodiment of the invention.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a data audit system according to one embodiment of the invention;

FIG. 2 is a data flow diagram for the data audit system;

FIG. 3 is an illustration of a user interface for a management console;

FIG. 4 is a schematic illustration of machines housing a database server and intermediate audit data;

FIG. 5 is a flow chart illustrating operation of data collection process executed by a collection agent;

FIG. 6 is a schematic illustration of a machine housing a repository server;

FIGS. 7A-B illustrate updating the configuration of a collection agent.

### DETAILED DESCRIPTION OF THE INVENTION

A description of preferred embodiments of the invention follows.

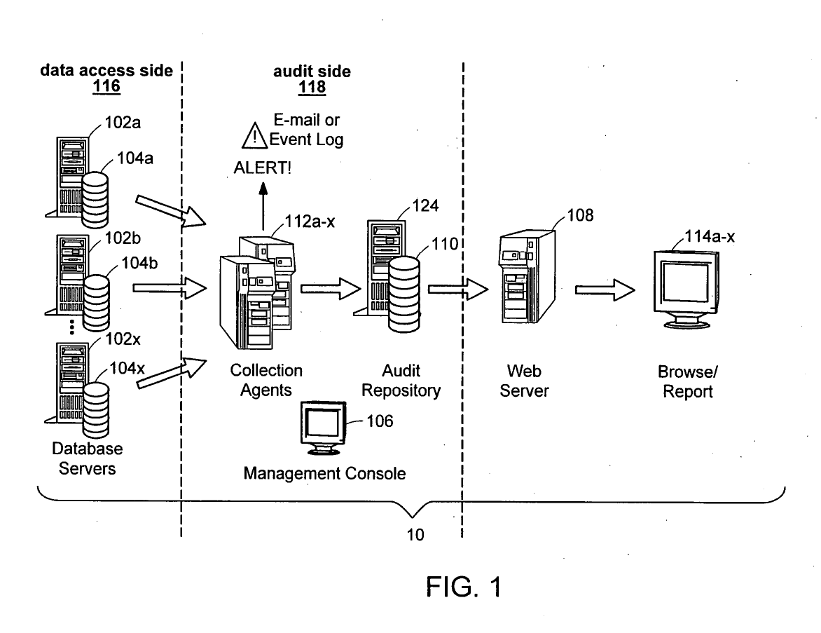

Illustrated in FIG. 1 is a data audit system that provides a number of capabilities: capturing a record of data access and permissions changes, managing the captured information for lengthy periods in a manner secure from tampering, flexibly analyzing the information, producing reports, and detecting conditions of interest for timely notification, while maintaining separation of duties for access to target and audit data. “Data audit,” as used herein, refers to keeping track of changes and access to the data for any reason, and not only for the official audit purposes. Data accesses include both data accesses for modification and for viewing. “Separation of duty,” as used herein, refers to a policy of keeping separate access to (1) data being monitored and (2) control over the monitoring mechanism and the resulting audit trails.

An audit is an important process in preserving data and maintaining a record of data accesses and modifications. In order to ensure the accuracy of this record, it is imperative to maintain both the audited data and the resulting audit data in a way most protected from tampering. If the same people or agents have control over the audited data and the audit process or the audit trail, it is hard to prove that the audit trail is complete because they could, theoretically, modify the audited data and then modify the audit process or data in such a way as to cover the initial modification. Therefore, it important that the target and audited data be maintained separately and that someone having access to the target data does not have control over the audit process. In one embodiment of the invention, this separation is maintained by making the audit control authentication process be independent of the database access authentication process. Furthermore, the database access authentication process may be independent of the audit control authentication process.

Data to be audited is stored in databases 104a-x located on corresponding database servers 102a-x. Collection agents 112a-x, each corresponding to one or more databases 104a-x, are tasked with collecting and organizing information about data accesses and changes in database structure. Collection agents 112a-x track and record audit information whenever target data is modified or viewed. Tracking may be performed on a periodic or as-needed basis.

There may be a logical separation between data access side 116 and audit side 118. Data access side 116 includes database servers 102a-x and target databases 104a-x and logically contains the target databases that are being monitored during an audit. Database servers 102a-x are typically maintained by database server maintainers who have permissions to modify target databases and their data. In addition, users accessing the database may read or modify the database data. Modification access permissions are enforced through authentication. Before an agent or a user is allowed to read or modify the target database, they have to go through an authentication process, generally requiring a password, to ensure they have appropriate permissions for the operation they are attempting to perform. Database maintainers may have sufficient permissions to modify significant amounts of data in the database or even to delete the database itself, which is why it is important to limit their access to the audit trail and configurations for the audit process.

If any modifications to the target database are made, they are reflected in the audit trail, and the same user who modified the database typically does not have adequate permissions to modify the audit trail of the original target data modifications. Similarly, collection agents 112a-x may have restricted permissions on the database servers 102a-x. In particular, collection agents 112a-x may only have read permissions on database servers 102a-x, so that they may monitor changes to the data, but might not be able to change the target data themselves. In an alternative embodiment of the invention, it may be sufficient for the collection agents 112a-x to have access only to the target database schema and/or dictionary, and to collect the rest of the audit data from the transaction logs.

In one embodiment of the invention, collection agents 112a-x are installed on the same machines as databases 104a-x. In an alternative embodiment of the invention, collection agents run on a separate machine from the one containing the monitored database(s).

Collected audit data is stored in a single logical audit repository 110, which may itself consist of multiple physical databases stored on multiple servers 124. In such a way, captured information is automatically collected from multiple databases into an easily managed long-term repository. In an alternative embodiment of the invention, there may be multiple repositories 110, logically divided based on the type and/or source of the audit trail information located in them, or based on any other factors, as determined by one skilled in the art.

Setup and management of the system 10 may be performed from a management console 106, which allows system administrators to configure auditing of all of the target servers, specify the activities of interest, the repository for managing the information, and the schedule for transferring data. In another embodiment of the invention, automatic monitoring for conditions of interest and generation of selected alerts may be set up along with the regular auditing activities.

Once the audit information is stored in the repository 110, it may be accessed through a web server 108 by clients 114a-x that can browse the audit trail and/or order or view automatically generated and custom reports. Web and other user interfaces on clients 114a-x provide a way for processing the stored information to identify activities of interest. Ad hoc and periodic exporting of analysis results in a variety of formats may be provided in one embodiment of the invention, allowing for display, printing and transmission of audit information. The data in the repository 110 may be accessed directly as well, either through standard database-access tools, or through proprietary access mechanisms. In one embodiment of the invention, direct access to the audit data is limited to audit managers.

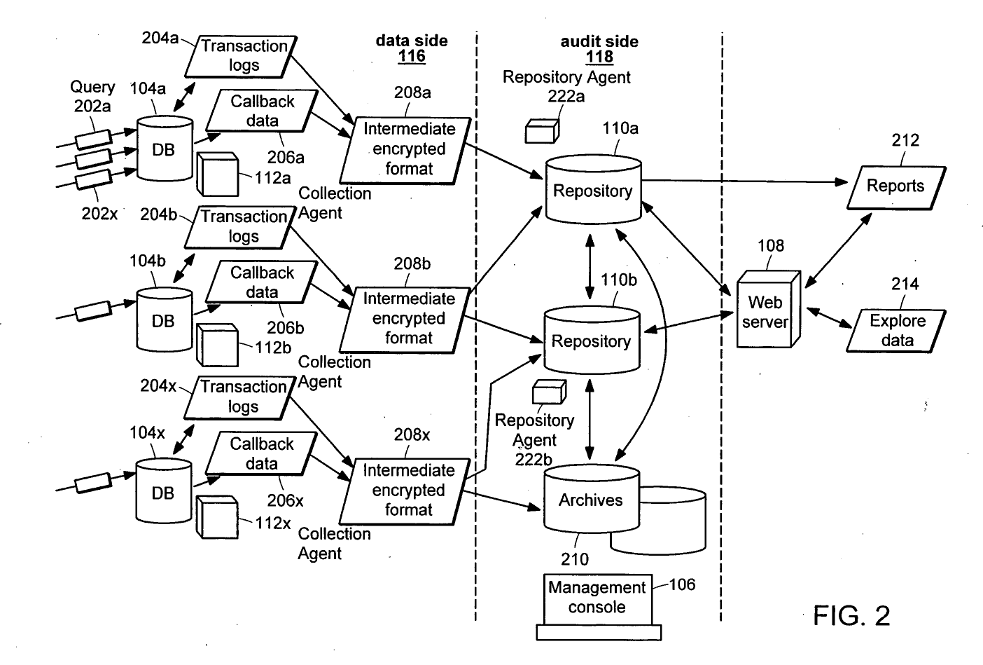

FIG. 2 is a data flow diagram illustrating movement of data inside the system 10. Transfer of the data may be accomplished using system communication devices or through a network, employing network protocols known in the art.

Queries 202 arrive at databases 104. Queries 202 may be Data Modification Language (DML) commands, inserting, deleting or modifying data in the database. In addition, queries 202 may include Data Definition Language (DDL) commands to modify the database schema or the database structure. Queries are processed at databases 104. In processing the queries, commercial databases (e.g. SQL Server, Oracle, DB2, Sybase, etc.) typically employ transaction log 204 to keep track of modifications to the data. A transaction log is a file that records all changes to user and system data. Transaction logs are described in further detail in U.S. patent application Ser. No. 09/861,830, incorporated herein by reference in its entirety.

The transaction logs are used as a master record of all changes to the data; they can be employed to recover data in the database in case of a fault, and can be archived to provide backup data. Before a data-modification action is executed on a database, a record of that action is written to a transaction log, such that if there is a fault during the execution of the action, the database can later be brought into a consistent state using the transaction log. Transaction logs 204 for each database 104 are typically stored on the same machine as that of the corresponding databases 104; however, in an alternative embodiment of the invention, transaction logs may be stored on a separate machine. Transaction logs 204 may include Undo and Redo logs or other data logging structures, as implemented by one skilled in the art. Data from transaction logs 204 may be gathered by the collection agents 112 for the audit trail.

In addition to transaction logs 204, in processing queries 202, databases 104 may generate callback data 206, comprised of data collected by executing predetermined functions in response to predetermined sets of conditions. Callback data may also include trace data, collected by tracing certain server events, that is, recording the events and their results.

In one embodiment of the invention, the trace data may be collected, for example, from SQL Server database server using the Profiler interface. Each trace that is executed may contain information about the event that is being profiled, how the results should be presented, and what data should be included in the trace. This trace information—events, data columns, and filters—describes what a SQL Server Profiler trace may capture in one embodiment of the invention. Events are incidents that cause the SQL Server Profiler to display an entry. Data columns determine what the trace stores in an entry. Filters determine the criteria (other than the occurrence of the event) that an event must meet before the SQL Profiler makes an entry. In an alternative embodiment of the invention, a similar profiling interface on an Oracle server may be employed. In yet another embodiment of the invention, the trace and callback data may be collected using other interfaces designed for that task. In yet another embodiment of the invention, data sniffing code may be integrated into a database engine. In yet another embodiment of the invention, the trace data may be collected by directing the database engine to store such data in a file or a database table, from which the trace data is then collected.

For each database 104, the data from the transaction logs 204 and the callback data 206 is collected by collection agent 112, which, in turn, converts the collected data into an intermediate format 208, which can be transferred to repositories 110.

Data from the transaction logs 204a-x and the callback data 206 altogether make up a record of internal database activities, which is collected by collection agents 112a-x. During the collection, collection agents 112a-x may need to store of the collected data in an intermediate format. In order to preserve the separation between the audit data and target data, the intermediate collected data is stored on separate machine from the machine housing the target database. Furthermore, collected data may be encrypted in order to prevent tampering. By encrypting data in the intermediate format 208, the system protects the collected audit data from being modified by an unauthorized agent or person and allows for such data to be safely sent over an unsecured network. When the audit data arrives at repositories 110, it may be decrypted and stored in an unencrypted format for easy analysis and access. In an alternative embodiment of the invention, audit data stored in repositories 110 is stored in an encrypted format.

Repositories 110 may be a set of database tables, for example, SQL tables. A single repository 110a may contain audit data from one or many databases. The repository 110a may reside on the same machine or SQL instance as the database being audited or on a separate machine/instance. In an alternative embodiment of the invention, database language other than SQL may be used. In yet another embodiment of the invention, repository 110 may be implemented as file systems, proprietary storage systems, or any other data storing mechanism as known in the art.

Repository agents 222 receive intermediate files 208 and store them in repositories 110. In addition, intermediate format files may be stored by the repository agents 222 in archives 210. Archives 210 may also store data from repositories 110, providing backup copies in case of a fault in one of the repositories 110.

Data in the databases 104a-x and transaction logs 204a-x can be viewed as logically belonging to the data access side 116, because it is modifiable by target database maintainers, users or agents having access to the target data. Data stored in repositories 110, on the other hand, can be logically viewed as belonging to the audit side 118 and may only be accessed by audit managers, and not by target database maintainers. While it is possible to have some limited permissions for database maintainers on the repositories 110 and for auditors and the target databases 104, such access permissions may be limited to read permissions.

Data from the repositories 110 may then be sent to web servers 108 in response to queries. The web servers 108, in turn, send the data received from repositories 110 to users in the form of reports 212 and data for user interface, providing exploration capabilities. Access to the repository data is not limited to that from the web servers 108 and may be accomplished by separate database exploration applications.

Repository data perusal may be viewed and managed through interactive reports, scheduled reports and custom reports. The data management functions are not limited to these three, and may be augmented as deemed necessary by one skilled in the art.

Interactive reports allow users to create and dynamically revise reports using the web user interface (not shown). This graphical web-based application enables users 114 to view, sort and filter audit information and produce reports. Data for the web user interface is provided by the web server 108.

Scheduled reports can be scheduled to run automatically at regular intervals using schedulers available on the client machine, such as, for example, the Windows scheduler. In one embodiment of the invention, such reports can use as default the configuration from the previous interactive report performed by the user.

Custom reports allow users to interface directly with the data in the repository, either by running queries through a database query interface, such as, for example, SQL Server Query Analyzer, or using a third-party report creation application. Alternatively, a report creation capability may be embodied in a system component provided with the repository.

Control of the data flow and system functions may be accomplished through a management console 106. The management console 106 is a tool that allows audit managers to set up and configure the environment of system 10 and to monitor the collection history. For example, the management console 106 may provide interface to define objects, such as databases, tables, and columns, that need to be audited, create repository servers 124, repositories 110 to contain audit data, and create alerts for particular database activity types, as well as assign notification methods to these alerts.

The management console 106 controls configurations of collection agents and audit data stored in repositories 110; therefore, it is important that the management console 106 is logically located on the audit side 118, and access to it is limited to audit managers. The separation between the audit side 118 and the target database side 116 may be accomplished through physical separation of files and servers or, in an alternative embodiment of the invention, through logical separation enforced even when parts of the two sides run on the same machine.

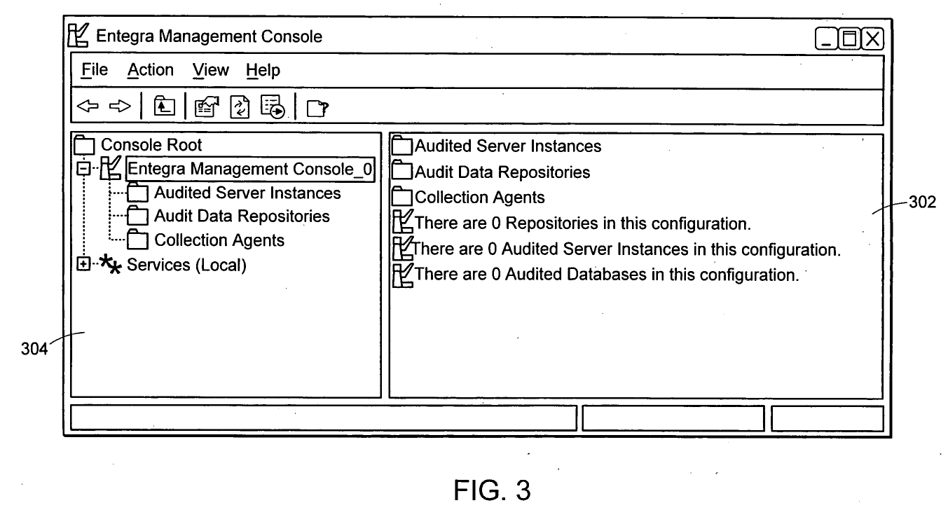

Illustrated in FIG. 3 is a user interface 302 for the management console 106. User interface 302 provides hierarchical view 304 for choosing to view particular sections of the system 10 and explore those sections in further detail.

The management console 106 may provide several interfaces—referred to as “wizards”—that facilitate configuration of the system 10. Such wizards may include, for example, Add Audited Server Instance wizard, Add Database wizard, Add Repository Server Instance wizard, Add Repository wizard, and others.

The management console 106 may run on a single machine or on a cluster of machines and may consist of multiple modules or a single application, as implemented by one skilled in the art. In an alternative embodiment of the invention, the management console 106 may come pre-configured with presets appropriate for a particular application of the system 10. For example, granularity of the collected data may be pre-configured based on the kind of data to be stored in the databases 104.

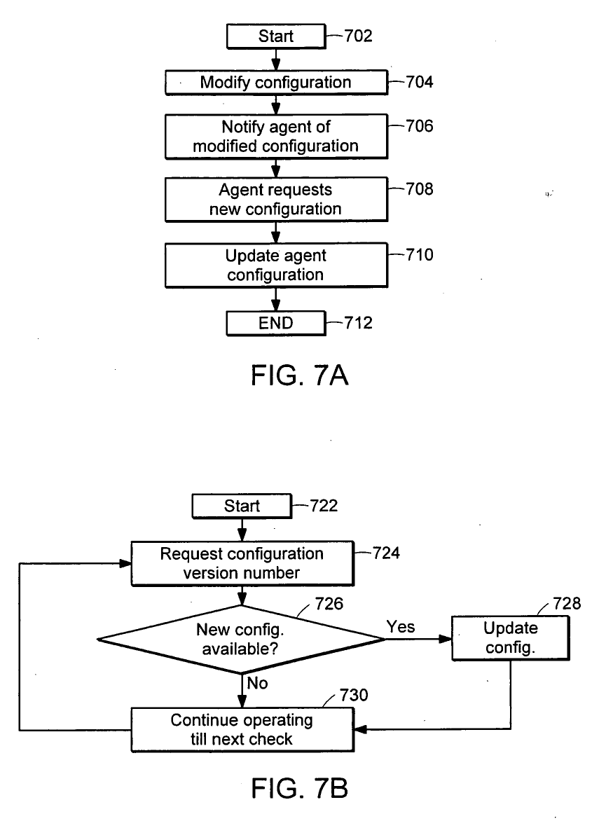

The management console 106 may also store configuration information for each of the collection agents 112. Such configuration information may be periodically transmitted to the configuration agents. In an alternative embodiment of the invention, the collection agents 112 may request the configuration information from the management console 106. The process of updating collection configuration is further discussed in connection with FIGS. 7A-B.

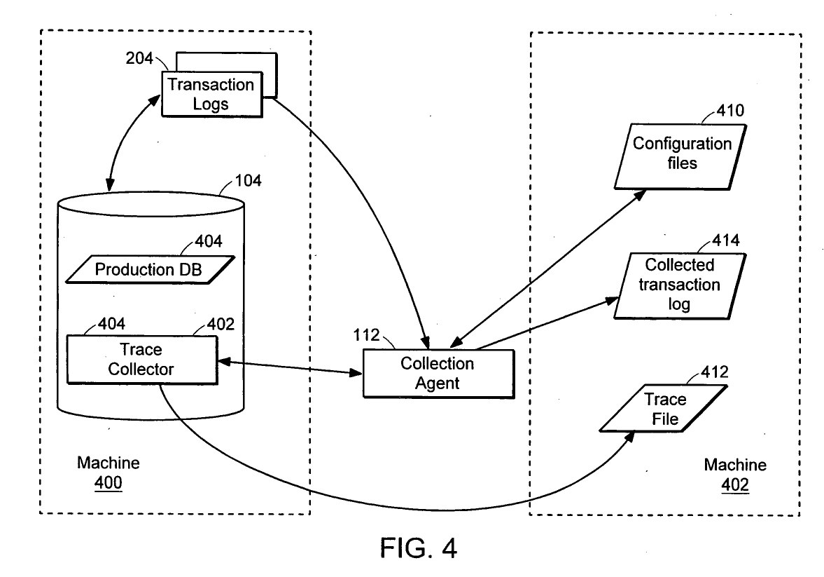

Each database server 104 may be located on multiple physical machines or on a single machine 400, as illustrated in FIG. 4. Typically, also located on the same machine are transaction logs 204.

The database server 104 may contain multiple databases, such as, for example, a configuration database storing configurations for the database server and production database 404, storing target data being audited.

Database server 104 may provide capabilities for executing certain functions in response to a particular command sent to the database. The results of executing these functions are referred to as “traces” and the task of collecting them is performed by the trace collector 402. Traces may be collected in response to critical commands, such as, for example, logging in and logging out of the database, changing the database schema and changing the database structure.

In addition to monitoring commands changing the structure of the database, trace collector 402 may be used to monitor who views data and what data is being viewed.

In an alternative embodiment of the invention, trace data may be collected by packet sniffing on the network on which the database server 102 is located: by capturing and processing the queries sent to the database server 102, the collection agent 112 may be able to gather information about executed commands related to viewing data, session establishment, and changing database structure or schema.

Collection agent 112 can gather data both from transactional logs 204 and traces collected by the trace collector 402, thus ensuring continued data auditing and wide scope of the audit trail that may encompass everything that happened to the data and the database. The resulting audit trail may contain a complete record of changes and be capable of showing the entire history: who made requests to change or view data and which data was requested. Collecting internal database activity data is further described in U.S. application Ser. No. 10/702,127, filed Nov. 5, 2003, which is incorporated herein by reference in its entirety.

Collection agent 112 may also be configured to specify which tables, items and instances of data have to be audited. Filtering may be applied at the collection agent 112, such that irrelevant data is filtered out and is not collected. Collection of trace and transactional data may happen automatically at predetermined times, for example, every hour. In between the collection times, data modifications are stored in the transaction logs 204 and trace data is stored in a trace file 412.

As discussed above, collection agent 112 may be physically located on the same machine 400 as the database server 104, or may be located on a remote machine, accessing the database server 104 through a network. The number of collection agents deployed need not correspond to the number of database servers running because a single collection agent may service multiple database servers.

Data collected by the collection agent 112 may be stored in a separate machine than database server 104 in order to ensure audit data integrity. The collection agent 112 need not have write permissions on data server 104 and may have only read permissions for the target data. The collection agent 112 may store intermediate collected data on the separate machine 402, where it is secured from access by those having write access to the database server 104. Collected intermediate data may comprise collected transaction log 414 and trace file 412, which may later be analyzed and processed together into the intermediate format 208.

In addition, stored on machine 402 may be configuration files 410 for the collection agent 112. The configuration files may indicate which tables and/or databases the collection agent should monitor, how often, and what information should be collected. Configuration files 410 may be distributed by the management console 106, as discussed below in connection with FIG. 7. Configuration files 410 may be stored in a configuration database, as separate files, or as objects maintained by the collection agent 112.

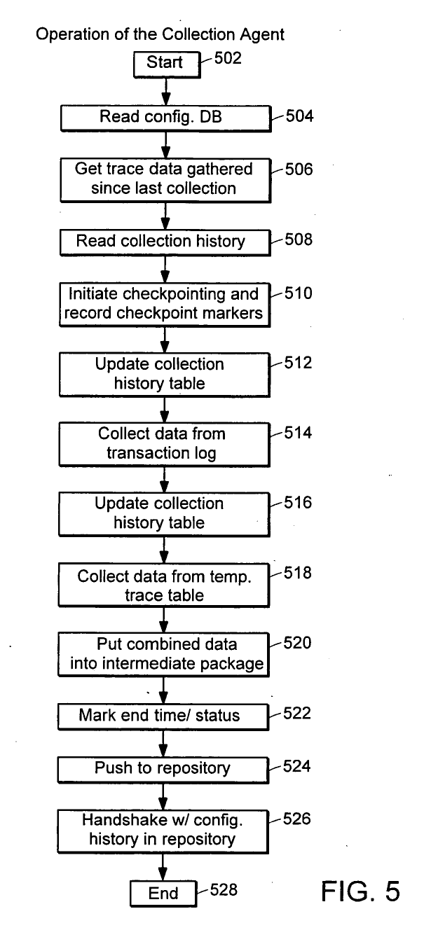

FIG. 5 illustrates operation of the collection process performed by the collection agent 112. When the collection agent 112 launches, either in response to a manual command or as part of a scheduled task, it first reads its configuration information. The configuration information for the collection agents 112 may be stored in a central database or some other file, or be requested from the management console 106. The configuration information tells the collection agent 112 which server instance(s) it is responsible for and how to contact and log into each audited server instance. The collection agent can then launch a collection process for each audited server instance.

The information about each audited server instance, including which databases to audit and which tables and columns within that database to audit, may be stored on the machine separate from the server itself. The collection agent reads this configuration information before connecting to the audited server instance. Keeping this information on the collection agent's machine allows for management of the audited server instance from multiple locations and ensures preservation of the audit configuration in the event of attempted tampering. In an alternative embodiment of the invention, the information about each audited server instance may be stored on the server machine itself.

The following types of data can be harvested by the collection Agents 112:

Data Modification Language (DML) operations

Data Definition Language (DDL) operations

Data access information (SELECT commands)

Transaction information

Session information

Security events

As used herein, database schema changing commands include commands for creating, modifying and/or deleting tables and table structure, while the term “database structure changing commands” includes any other commands modifying structure of the database, for example, security-related commands such as modifying access permissions.

Collection process starts in step 502, after which the collection agent 112 reads configuration files 410 in step 504. Configuration files 410 may include a collection table (see FIG. 7) containing collection history and indicating which data has already been collected.

In step 506, the collection agent 112 can gather trace data collected since the last collection time. This trace data may be collected from the trace file 412 from additional storage provided by the database server 104 itself.

The collection agent 112 then proceeds to read the collection history in step 508. Typically, collection of data from the transaction log 204 may be delineated by recordation of the checkpoint markers. Checkpointing is a process performed periodically on the database server 104 to ensure that identical data is stored in the production database 404, transactional logs 204 disk drives, and any additional storage. If it were not for the checkpointing process, at times different data may be stored in those places because of inherent features of having to write data to multiple locations.

Checkpointing may be performed automatically by the database server 104, but it may also be initiated by outside agents. The collection agent 112 initiates checkpointing on the database in step 510. Each checkpoint is recorded in the transaction log 204 using a checkpoint marker. The checkpoint marker is typically a unique number, identifying the checkpoint, and the time at which the checkpoint was performed. The checkpoint markers may be used to keep track of which data has been collected from the transaction log 204. By recording checkpoint markers in the collection table, the collection agent 112 makes sure that it collects continuous and not gapped or overlapping data.

The collection agent 112 then updates the collection history table in step 512 to store data about the current collection process, such as, for example, import start time, and data start checkpointing marker, as well as current status of the collecting process.

Once the data from the transaction log has been collected (step 514), the collection history table is updated in step 516 to record the import end time and any other additional information, such as, for example, status information.

Additional data may then be collected in step 518 from the temporary trace table 412. Trace and transactional data are combined into an intermediate package in step 520, after which the collection agent 112 marks end time and status of the collection in the collection table in step 522.

The intermediate file 208 is sent to the repository agent 222 on the repository machine in step 524. The status of transferring the intermediate file 208 may be recorded in the collection table as well. The intermediate file 208 may be encrypted before the transfer. The collection table is set up in such a way that if any of the operations performed by the collection agent, including transferring of the data to the repository agent, fail, the next time that the collection process is run, the collection agent 112 will collect all data that has not been fully collected in the previous collection.

When transfer of the intermediate file 208 to the repository is complete, the collection agent 212 handshakes with the repository agent 222 at 526 to transfer control over the intermediate file 208. After the intermediate file 208 is transferred, the collection process is complete at 528.

Importing data into the repository 110 is performed by the repository agent 222. In one embodiment of the invention, the repository agent 222 runs as a service on the repository machine. After the intermediate file 208 is received from the collection agent, the repository agent 222 extracts the data from the intermediate file 208, decrypts it and uses it to populate the repository 110. After importing is complete, the data is ready to be viewed and queried. The intermediate file 208 may also be stored on the repository machine or in the archive 210.

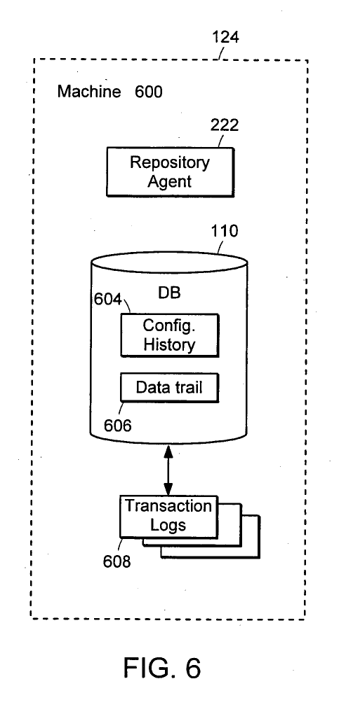

FIG. 6 illustrates a machine housing a repository server 110. As with the database server 104, repository server may be housed on a single machine or on multiple physical computers. There may be more than one repository, referred to jointly herein as repository server 110. The server 110 may serve two databases: a configuration database 604 and a database containing the audit trail data 606.

The repository agent 222 may be located on the same machine as the server 110. A single repository agent 222 may service multiple repository servers 110 or multiple instances of one server. In an alternative embodiment of the invention, the repository agent 222 is located on a separate machine and communicates with the database server 110 through the network, thus making the performance load lighter for the machine 600.

Repository server 110 may have its own transaction logs 608, used to preserve integrity of the data trail database 606. However, these transaction logs 608 are more of a feature of the repository being a database, rather than a requirement of the system. In an alternative embodiment of the invention, the repository database 606 may be implemented as a file system.

The archive 210 may be used for housing audit data as determined by the system administrator. Such data may be arranged, for example, for copying onto more permanent storage medium, such as, for example, backup tapes. The management console 106 may be used to set up preferences for archiving of data in the archive 210. In one embodiment of the invention, the system administrator may set the date ranges for data stored in the archive 210. In another embodiment of the invention, the system administrator may use the management console 106 to set up filters for the audit data to be stored in the archive 210. Such filters may be based, for example, on specific tables and databases, as well as the kind of data to be stored, such as, for example, information about who modified data in the databases or who viewed which data in the databases. The archive 210 may itself be one or multiple databases with their own recovery mechanisms.

FIGS. 7A and 7B illustrate alternative methods for delivering configuration information to collection agent 112. FIG. 7A illustrates a process, in which the management console 106 is responsible for notifying the collection agents when there are changes to their configuration data. The configuration is modified in step 704 by an audit manager or another agent or user that has write access permissions on the management console 106. After the modification of configuration is complete, management console 106 notifies the collection agent 112 in step 706. The notification does not include a copy of the configuration itself, so that it is not intercepted in transmission. The collection agent 112 then requests the new configuration from the management console 106 in step 706. The address of the management console 106 may be stored in the collection agent and might not be modifiable during the operations of the audit. In an alternative embodiment of the invention, the notification of the modified configuration also contains an IP or a URL address from where the agent should request its new configuration. After the request is received, the new configuration is sent to the collection agent 112 in step 710. Configuration information may be transferred in an encrypted or unencrypted format over a secured or unsecured network. When the collection agent 112 receives the configuration information, it updates its configuration and proceeds to operate according to the new settings.

In an alternative embodiment of the invention, the collection agents 112 periodically check for updated configuration information, as illustrated in FIG. 7B. A collection agent may find out about a new configuration by, for example, requesting a new configuration version number (step 724) or by requesting some other indication of the new configuration. If a new configuration is available (step 726), it is transmitted to the collection agent 112, which then updates its configuration (step 728), after which the collection agent continues operating until it is time to once again check for new configuration (step 730).

The system may be set up in such a way that, if there is no communication between the collection agent and management console 106 for a predetermined period of time, the collection agents attempt to restore the configuration but, meanwhile, continue to collect audit data. By allowing the agents to operate independently, the system ensures that the audit might not be tampered with by interrupting the network access from the management console 106 to the collection agents 112. In an alternative embodiment of the invention, system 10 may keep track of when the network is unavailable and may record that information as part of the audit data.

The configuration files used by the collection agents 112 may be in any standard of proprietary format, as deemed appropriate by one skilled in the art. For example, the configuration files may be XML files. Each collection agent maintains a copy of its configuration file at all times in order to be able to operate if the management console 106 goes down. In case the repositories 110 are also down, the collection agents 112 may queue data to ensure that no data is lost. In one embodiment of the invention, collection agents 112 do not store state data or collected data on the target database; instead they store the data locally in the agent or on a separate machine.

Because of the restricted access permissions on the target databases 104 and repository 110, the installation of system 10 may be separated into two or more steps performed by people with separate assigned roles. For example, the database maintainers may set up databases 104 and install the collection agents 112, without having write access to the repositories 110 or the management console 106. In turn, the audit managers may install and create repositories 110 and the management console 106, without having the write access target databases 104. Depending on where the collection agent 112 is located, the database maintainers or the audit managers may be responsible for setting up the collection agent. In an alternative embodiment of the invention, a separate manager may be assigned to the installation of the collection agents 112.

In order to facilitate the separate installation steps, software for the system 10 may be provided on multiple media, for example, on multiple CDs, each containing programs and instruction for a particular installation step. The companies using system 10 and intending to ensure the utmost audit integrity may assign different people to separate installation and maintenance tasks, making sure that no single person has write access to both the target database machines and the audit repository machines. The starting and ending of the operation of the collection agents may also be recorded as part of the audit data, in order to maintain information about when the data is collected. While the system 10 cannot prevent tampering, it can detect it by maintaining a thorough audit log and auditing the database transaction log. If the database transaction log 204 has been tampered with, such tampering may be detectable through log sequence numbers, which are recorded in the transaction log 204.

If a person skilled in the art determines that the system 10 needs additional security, a firewall may be installed between the data side 116 and the audit side 118. Additional security measure may be taken, as deemed necessary by one skilled in the art.

In the most practical and secure system, the databases 104 are on a separate machine from at least the audit repository 110 and other audit data. However, with appropriate authentication requirements and policies for separating user tasks, the processes may be stored in a common machine.

While this invention has been particularly shown and described with references to preferred embodiments thereof, it will be understood by those skilled in the art that various changes in form and details may be made therein without departing from the scope of the invention encompassed by the appended claims.

What is claimed is:

1. A database audit system comprising:
a target database to be monitored, the target database being accessed through an authentication process;
an agent that monitors the internal database activity of the target database according to a set of configuration parameters, operation of the agent being independent of access to the target database through the authentication process; and
a configuration manager that stores configuration parameters for access and use by the agent, the configuration manager being accessed through an authentication process independent of the target database authentication process.

2. A database audit system as claimed in claim 1 wherein the agent has limited privileges in the target database.

3. A database audit system as claimed in claim 2 wherein the privileges are limited to read only.

4. A database audit system as claimed in claim 1 wherein the authentication process of the target database is independent of the authentication process of the configuration manager.

5. A database audit system as claimed in claim 4 wherein a target database administrator has limited privileges in the configuration manager.

6. A database system as claimed in claim 1, further comprising:
data stored temporarily by the agent in a data storage separate from the target database.

7. A database system as claimed in claim 1, further comprising:
an audit repository database storing information collected by the agent.

8. A database system as claimed in claim 7 wherein the audit repository is accessed through an authentication process independent of the target authentication process.

9. A database system as claimed in claim 7 wherein data is transferred from the agent to the audit repository in an encrypted format.

10. A database system as claimed in claim 7 wherein the agent internally queues collected data in case of unavailability of the audit repository database.

11. A database system as claimed in claim 1 further comprising:
agent configuration data stored in the agent.

12. A database system as claimed in claim 1 further comprising:
a first computer readable medium storing instructions for installing the agent; and
a second computer readable medium storing instructions for installing the configuration manager.

13. A database system as claimed in claim 1, wherein the internal database activity is recorded in a transaction log and a trace of database activities including session activities after session establishment.

14. A computer-implemented database audit process for a target database having an associated authentication process, said audit process comprising:
maintaining a record of the target database internal activity;
collecting the record of the target database internal activity by an agent, the operating of the agent being independent of access to the target database through the authentication process; and
storing configuration parameters for access and use by the agent at a configuration manager, the configuration manager being accessed through an authentication process independent of the target database authentication process.

15. A computer-implemented database audit process of claim 14 wherein the authentication process of the target database is independent of the authentication process of the configuration manager.

16. A computer-implemented database audit process of claim 14 further comprising:
limiting privileges of the agent on the target database.

17. A computer-implemented database audit process of claim 16 further comprising:
limiting the privileges of the agent on the target database to read only permissions.

18. A computer-implemented database audit process of claim 14 further comprising:
transmitting data collected by the collection agent to an audit repository.

19. A computer-implemented database audit process of claim 18 further comprising:
encrypting the data collected by the collection agent before transmitting it to the audit repository.

20. A computer-implemented database audit process of claim 18 further comprising:
queuing the data collected by the collection agent in the collection agent if the audit repository is unavailable.

21. A computer-implemented database audit process of claim 14 further comprising:
requesting, by the agent, a new set of configuration parameters from the configuration manager.

22. A computer-implemented database audit process of claim 14 further comprising:
notifying, by the configuration manager, the agent of a new set of configuration parameters.

23. A computer-readable medium storing instructions for auditing a target database having an associated authentication process, said instructions comprising:
instructions for maintaining a record of the target database internal activity;
instructions for collecting the record of the target database internal activity by an agent, the operating of the agent being independent of access to the target database through the authentication process; and
instructions for storing configuration parameters for access and use by the agent at a configuration manager, the configuration manager being accessed through an authentication process independent of the target database authentication process.

24. A computer-readable medium of claim 23 wherein the instructions for auditing the target database further comprise:
instructions for enforcing authentication process for write access to the target database independently of the authentication process of the configuration manager.
